(19) United States
(12) Patent Application Publication
(10) Pub. No.: US 2017/0032329 A1
(43) Pub. Date: Feb. 2, 2017

(54) METHODS AND SYSTEMS FOR BOOKING AND MANAGING PERSONAL SERVICE APPOINTMENTS

(71) Applicant: Scott Keller, Waterloo (CA)

(72) Inventor: Scott Keller, Waterloo (CA)

(21) Appl. No.: 15/223,216

(22) Filed: Jul. 29, 2016

Related U.S. Application Data
(60) Provisional application No. 62/198,398, filed on Jul. 29, 2015.

(51) Int. Cl. G06Q 10/10; H04L 29/08; G06F 17/30

(52) U.S. Cl. CPC G06Q 10/1095; G06F 17/30867; H04L 67/18

(57) ABSTRACT

Methods and systems are provided for booking an appointment within a scheduling database connected to the Internet. The method comprises recording a plurality of appointment schedules in the scheduling database. Each appointment schedule is associated with a service-provider organization as well as a plurality of appointments. Each appointment is associated with a service-provider individual, a time slot, as well as an available/unavailable indicator. A consumer using a service-consumer device can search the scheduling database for available appointments based on such criteria as type of service, appointment time, location, and product brands offered by the service provider. A user rating associated with the service consumer can be updated so that services providers can make decisions about accepting appointment books from particular service consumers.

### RELATED APPLICATIONS

This application claims the benefit of U.S. Provisional Patent No. 62/198,398 filed Jul. 29, 2015 and entitled METHODS AND SYSTEMS FOR BOOKING AND MANAGING PERSONAL SERVICE APPOINTMENTS, the entire contents of which are hereby incorporated by reference herein for all purposes.

### TECHNICAL FIELD

The embodiments disclosed herein relate to providing personal services, and in particular, to booking and managing personal service appointments.

### SUMMARY

According to some embodiments, there is a method for booking an appointment within a scheduling database connected to the Internet. The method comprises recording a plurality of appointment schedules on at least one non-transitory computer-readable medium. Each appointment schedule is associated with a service-provider organization, and a plurality of appointments. Each appointment is associated with a service-provider individual within the service-provider organization, a time slot, and an associated available/unavailable indicator.

A search-provider search request is received from a service consumer via the Internet, and search results are provided to the service consumer based on the search request. The search results correspond to a particular appointment.

A booking request is received from the service consumer, which corresponds to the particular appointment, and the service provider organization is notified of the booking request.

The step of recording a plurality of appointment schedules may comprise associating each appointment schedule with a plurality of active/inactive time periods, and associating each active/inactive time period with an active/inactive indicator. If the active/inactive indicator indicates “inactive”, and the active/inactive time period corresponds to the time slot of a particular appointment, then the step of presenting the search result further comprises not presenting the search result.

The search request may comprise a location and a maximum distance, and the search results may be derived from a location-based search for service-providers located within a proximity of the location defined by the maximum distance. The location may be automatically determined by a GPS receiver associated with the service consumer.

A rating indicator pertaining to the service consumer may be recorded on the at least one non-transitory computer-readable medium. The indicator may be based on a failure by the service consumer to attend a previously-scheduled appointment.

A feature listing indicator associated with the service-provider organization may be recorded on the at least one non-transitory computer-readable medium. Search results may be provided in a relative order based on the feature listing indicator.

According to some embodiments, there is a system for booking appointments for a multitude of service consumers on the Internet, and managing the appointments by a multitude of service-provider organizations and service-provider individuals via the Internet. The system comprises a service-appointment server having a service-appointment processor, at least one non-transitory computer-readable medium, a service-consumer device having a service-consumer processor, a service-provider-organization device having a service-provider-organization processor, and a service-provider-individual device having a service-provider-individual processor device.

Medium stores a service-appointment database that stores an appointment schedule associated with a service-provider organization, and comprising an appointment associated with a service-provider individual and an available/unavailable indicator.

The service-appointment database is in communication with the service-appointment server. The service-consumer device is in communication with the service-appointment server via the Internet. The service-provider-organization device is in communication with the service-appointment server via the Internet. The service-provider-individual device is in communication with the service-appointment server via the Internet.

The service-appointment processor is configured to receive the server-provider search request from the service-consumer device, provide the service-provider search results based on the database and the service-provider search request, receive the selected appointment from the service-consumer device, provide a servicer-provider-organization booking message to the service-provider organization device, and provide a service-provider-individual booking message to the service-provider-individual device pertaining to the selected appointment.

The service-provider-organization processor is configured to provide the database with the appointment schedule, and receive the service-provider-organization booking message from the service appointment server.

The service-provider-individual processor is configured to update the available/unavailable indicator pertaining to the appointment, and receive the service-provider-individual booking message from the service-appointment server.

The appointment schedule may be associated with a plurality of active-inactive time periods, and the service-provider-organization processor may be configured to update an active-inactive indicator associated with each of the inactive/inactive time periods. The service-appointment processor may be configured to provide the service-provider search results if and only if the active-inactive indicator associated with the active/inactive time period corresponding to the selected appointment indicates “active”.

The service-consumer device may comprise a GPS receiver, and the service-provider search request may comprise a location automatically determined by the GPS receiver and a maximum distance. The service-provider search results may be derived from a location-based search for the service-providers located within a proximity of the location defined by the maximum distance.

The service-appointment processor may be configured to determine a service-consumer rating indicator pertaining to a service consumer based on a failure by the service consumer to attend a previously-scheduled appointment. At least one of the service-provider-organization booking message and the service-provider individual booking message may comprise the service-consumer rating indicator.

The service-provider-organization processor may be configured to provide a feature listing indicator in association with a service-provider organization. The service-appointment processor may be configured to provide the search results in an order relative to a second search result that is based on the feature listing indicator.

### BRIEF DESCRIPTION OF THE DRAWINGS

The drawings included herewith are for illustrating various examples of articles, methods, and apparatuses of the present specification. In the drawings:

FIG. 1 is a schematic view of a system for booking appointments for a multitude of service consumers on the Internet, according to one embodiment;

FIG. 2 is a diagram of a graphical user-interface on a service-consumer device, according to one embodiment;

FIG. 3 is a diagram of a graphical user-interface on a service-consumer device, according to one embodiment;

FIG. 4 is a diagram of a graphical user-interface on a service-consumer device, according to one embodiment;

FIG. 5 is a diagram of a graphical user-interface on a service-consumer device, according to one embodiment;

FIG. 6 is a diagram of a graphical user-interface on a service-consumer device, according to one embodiment;

FIG. 7 is a diagram of a graphical user-interface on a service-consumer device, according to one embodiment;

FIG. 8 is a diagram of a graphical user-interface on a service-consumer device, according to one embodiment;

FIG. 9 is a diagram of a graphical user-interface on a service-consumer device, according to one embodiment;

FIG. 10 is a diagram of a graphical user-interface on a service-consumer device, according to one embodiment;

FIG. 11 is a diagram of a graphical user-interface on a service-provider-organization device, according to one embodiment;

FIG. 12 is a diagram of a graphical user-interface on a service-provider-organization device, according to one embodiment;

FIG. 13 is a diagram of a graphical user-interface on a service-provider-organization device, according to one embodiment;

FIG. 14 is a diagram of a graphical user-interface on a service-provider-organization device, according to one embodiment;

FIG. 15 is a diagram of a graphical user-interface on a service-provider-organization device, according to one embodiment;

FIG. 16 is a diagram of a graphical user-interface on a service-provider-organization device and/or a service-provider individual device, according to one embodiment;

FIG. 17 is a diagram of a graphical user-interface on a service-provider-organization device and/or a service-provider individual device, according to one embodiment;

FIG. 18 is a diagram of a graphical user-interface on a service-provider-organization device and/or a service-provider individual device, according to one embodiment;

FIG. 19 is a diagram of a graphical user-interface on a service-provider-organization device, according to one embodiment;

FIG. 20 is a diagram of a graphical user-interface on a service-provider-organization device;

FIG. 21 is a diagram of a graphical user-interface on a service-provider-organization device;

FIG. 22 is a diagram of a graphical user-interface on a service-provider-organization device;

FIG. 23 is a diagram of a graphical user-interface on a service-provider-organization device;

FIG. 24 is a diagram of a graphical user-interface on a service-provider-organization device;

FIG. 25 is a diagram of a graphical user-interface on a service-provider-organization device;

FIG. 26 is a diagram of a graphical user-interface on a service-provider-organization device or a service-provider individual device according to some embodiments;

FIG. 27 is a diagram of a graphical user-interface on a service-provider-organization device or a service-provider individual device according to some embodiments;

FIG. 28 is a diagram of a service-provider-organizations' website; and

FIG. 29 is a flow diagram of a method for booking an appointment within a scheduling database connected to the Internet.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

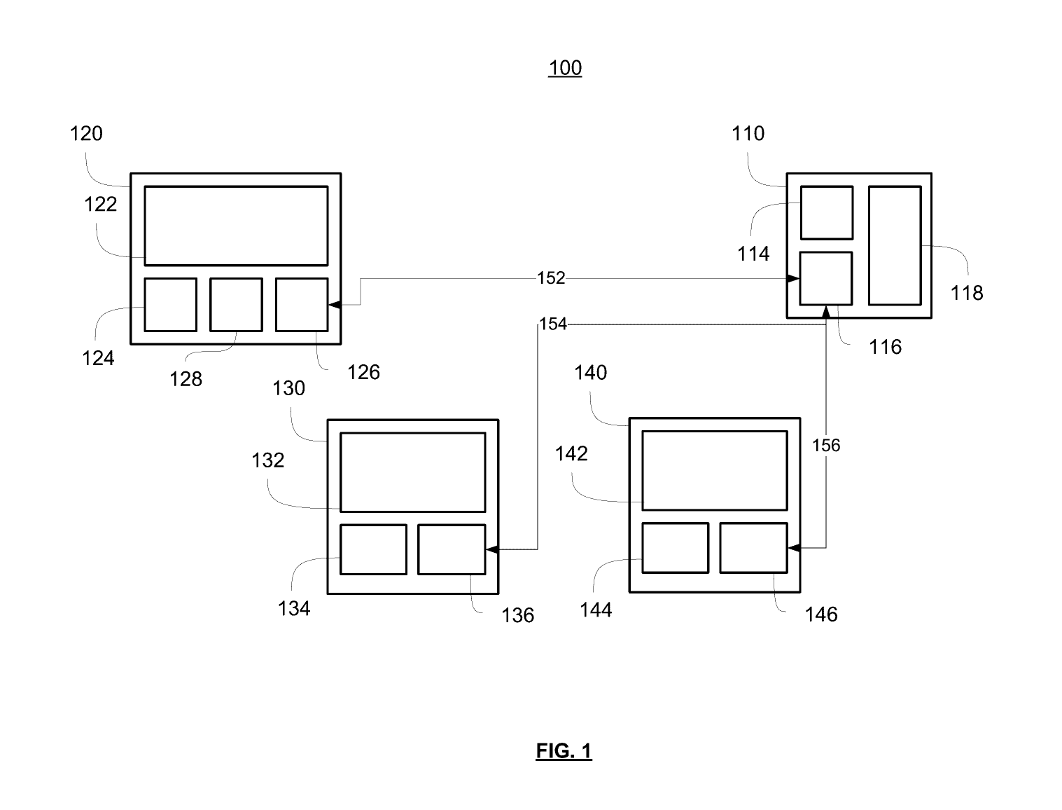

Referring to FIG. 1, there is a system 100 for booking appointments for a multitude of service consumers on the Internet, and for managing the appointments by a multitude of service-provider organizations and service-provider individuals. The system 100 comprises a service-appointment server 110, a service-consumer device 120, a service-provider-organization device 130, and a service-provider-individual device 140.

The service-appointment server 110 comprises a processor 114, a communications module 116, and a non-transitory computer-readable medium or storage device 118 that is capable of storing a database. According to some embodiments, the storage device 118 may be physically enclosed within the service-appointment server 110, while in other embodiments, the storage device 118 may be located separately from the service-appointment server 110. According to some embodiments, the storage device 118 may include more than one storage device, and the database stored may comprise one or more databases distributed across one or more storage devices.

The service-appointment server 110 is in communication with the service-consumer device 120 via the Internet connection 152. FIG. 1 has been simplified for the purposes of illustration to depict a single service-consumer device 120 in communication with the service-appointment server 110. However, in practice, the number of service-consumer devices 120 will be in the thousands, tens-of-thousands, hundreds-of-thousands, or millions, since seemingly almost any person with access to the Internet is capable of operating a service-consumer device 120 at any given time.

The service-consumer device 120 comprises a display 122, a processor 124, and a communications module 126. According to some embodiments, the service-consumer device 120 may be a personal computer or laptop computer, or another mobile device such as a smart phones, tablet, smart watch, etc.

According to some embodiments—for example, when the service-consumer device 120 is a mobile device—the service-consumer device 120 may further comprise a global-positioning-system (GPS) receiver 128. The GPS receiver 128 can be used to automatically determine the location of the service-consumer device 120, so that the current location of the service consumer can be used as the basis for a location-based search for service providers.

The service-provider-organization device 130 comprises a display 132, a processor 134, and a communications module 136. The service-provider-organization device is generally located at the place of business of the service-provider organization (e.g. a salon), though, according to some embodiments, the service-provider-organization device 130 may be a mobile device. The service-provider-organization device 130 is in communication with the service-appointment server 110 via Internet connection 154.

The service-provider-individual device 140 comprises a display 142, a processor 144, and a communications module 146. The service-provider-individual device is generally a mobile device that is operated by a particular service-provider individual (e.g. an individual hair stylist who may be an employee of a salon). The service-provider-individual device 140 is in communication with the service-appointment server 110 via Internet connection 156.

The communications modules 116, 126, 136, and 146 may be any type of communications transceiver, radio, modem, etc., that is capable of Internet communications, such as an Ethernet adapter, a wireless Ethernet adapter, a cellular data network radio, etc.

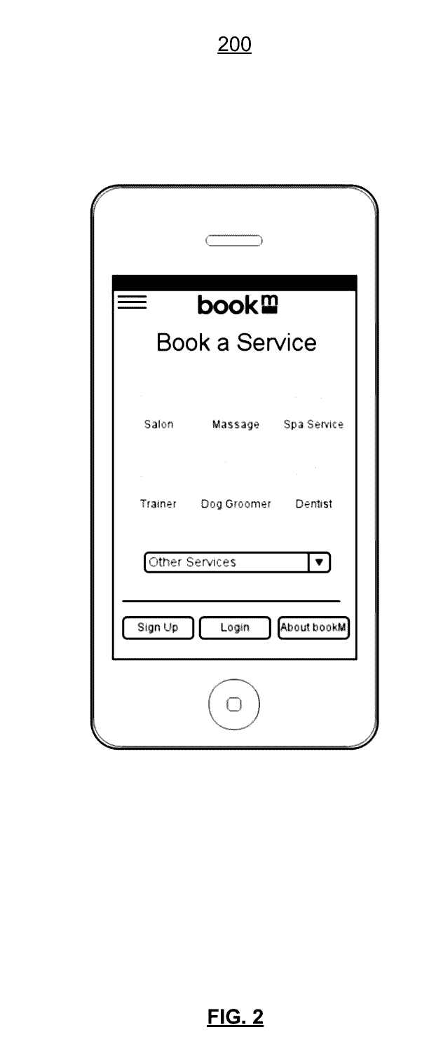

Referring to FIG. 2, there is shown a graphical user-interface (GUI) 200 on a service-consumer device configured for initiating a search for a service appointment. The GUI 200 displays icons that allow for a type of service to be selected, such as “Salon”, “Massage”, “Spa Service”, “Trainer”, “Dog Groomer”, and “Dentist”. Other services may include medical, dental, automotive, etc. A service consumer using the GUI 200 is able to select a type of service for which an appointment is desired by selecting the appropriate icon. Furthermore, additional services can be selected by way of the drop-down list located below the icons.

According to some embodiments, the GUI 200 also includes buttons, located at the bottom of the GUI 200, so that a service consumer can sign up or login to the system. If a service consumer selects either of these buttons, he or she is presented with a subsequent GUI (not shown) that allows for the service consumer to sign up (i.e. create a new user account) or login (i.e. using an existing user account).

According to some embodiments, it is not necessary for the service consumer to sign up or login to the system in order to conduct a search for a service appointment.

According to some embodiments, if the service consumer is logged in to the system, then the service categories (e.g. displayed as icons, and/or ordered in the drop-down list) can be personalized to the service consumer based on past appointments bookings. Otherwise, the service categories can be featured in a default priority.

The GUI 200 includes a menu button in the top left corner that provides access to a “Home” screen, a “My Bookings” screen, a “My Account” screen, and a “Service Provider Login” screen.

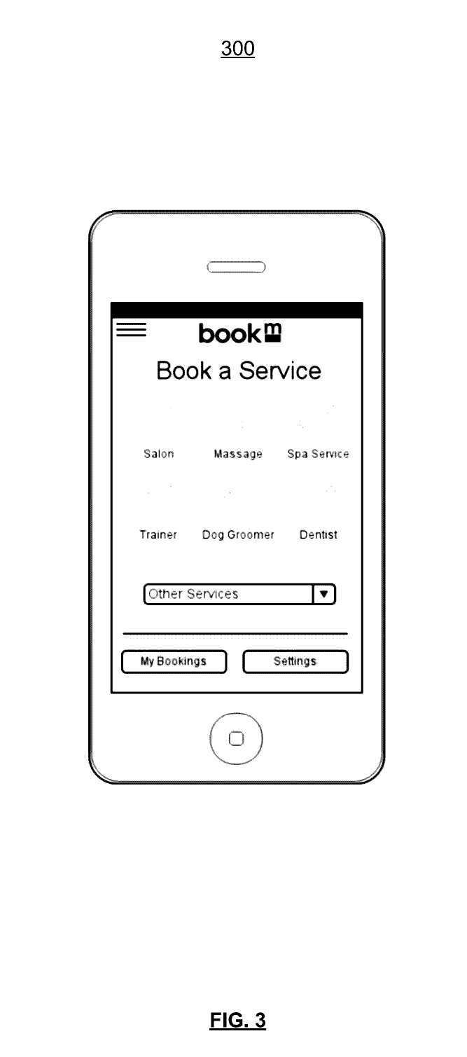

Referring to FIG. 3, there is shown a GUI 300 on a service-consumer device that is displayed when a service consumer has logged in to the system. After the service consumer has logged into the system, such as after viewing the GUI 200 and selecting the “login” button, the GUI 300 displays additional buttons that allow the service consumer to access “My Bookings” and “Settings” that pertain to the particular service consumer.

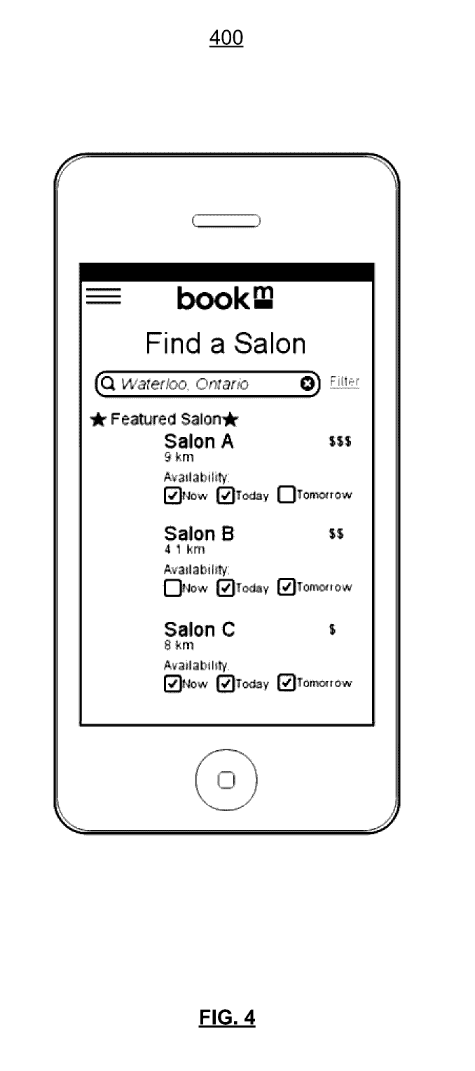

Referring to FIG. 4, there is shown a GUI 400 on a service-consumer device displaying example location-based search results based on the location “Waterloo, Ontario”. In this example, the service-consumer device may have automatically determined the service consumer's location to be “Waterloo, Ontario”, for example, based on a GPS receiver, IP address, etc., or, alternatively, the service consumer may have manually entered the “Waterloo, Ontario” as the location. According to some embodiments, a default location, such as “Waterloo, Ontario” can be established for use as a location when a different location is not provided. According to some embodiments, location information (e.g. default location, the option to use the current location, etc.) may be set in the settings associated with the service consumer's user account.

When the location is determined, and a search is executed (e.g. by selecting an icon on the GUI 200 or the GUI 300), the service-consumer device sends the search criteria (e.g the location) to the service-appointment server. The service-appointment server then queries the server-appointment database based on the search criteria, compiles a list of search results, and returns the list of search results to the service-consumer device.

In the example of GUI 400, three salons—Salon A, Salon B, and Salon C—are listed. According to some embodiments, this list can be produced by selecting the “Salon” icon, such as is found in the GUI 200 or the GUI 300, after which, the GUI 400 may be displayed.

According to some embodiments, the default listing order for the search results is based on proximity to a particular location. However, other listing orders are possible. For example, as shown in the example of GUI 400, Salon A is listed first (at the top of the list), since it is a featured salon.

According to some embodiments, a feature-listing indicator can be recorded in a service-appointment database in association with a service-provider organization. This can be accomplished when a service-provider organization chooses a feature listing, such as by purchasing the feature listing from the system provider. The feature listing can be set using the service-provider-organization device, and provided to the database via the service-appointment server.

As can be seen in the example of GUI 400, when search results are displayed and one of the search results includes a feature listing, the search result pertaining to the service-provider organization associated with the feature listing will be listed at a higher priority than other search results. Thus, even though Salon B is closer (4.1 km) than Salon A (9 km), Salon A is displayed at the top of the search results list, since it has a feature listing as a “featured salon”.

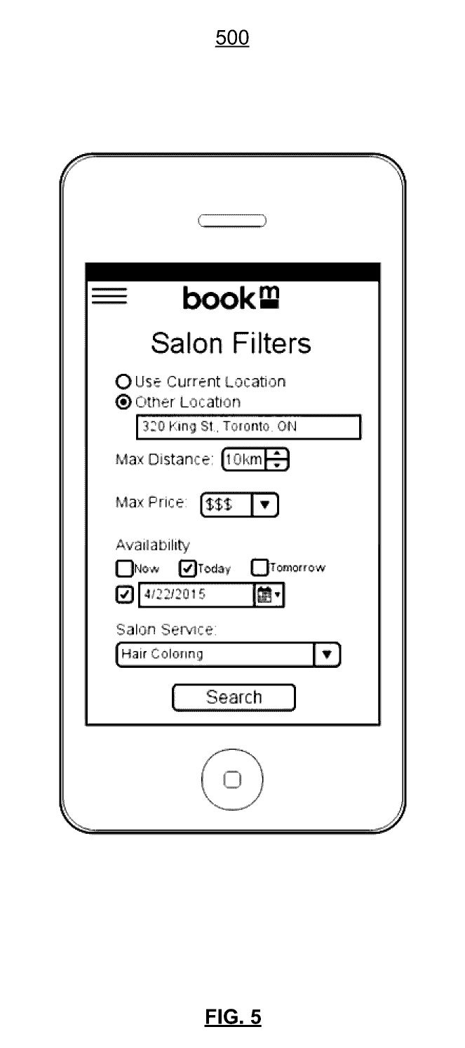

Referring to FIG. 5, there is shown a GUI 500 on a service-consumer device. The GUI 500 allows a service consumer to provide filters or search criteria. For example, as shown, the service consumer can select between “Use Current Location” (such as a location established by a GPS receiver, IP address, etc.), and “Other Location”. Furthermore, a service consumer can specify a maximum distance to be used as the proximity for a location-based search, the maximum price, availability, and particular categories or types of services (e.g. “hair coloring” as a type of service offered by a hair salon). Search results will be subsequently displayed only when they meet the filters or search criteria set by the service consumer.

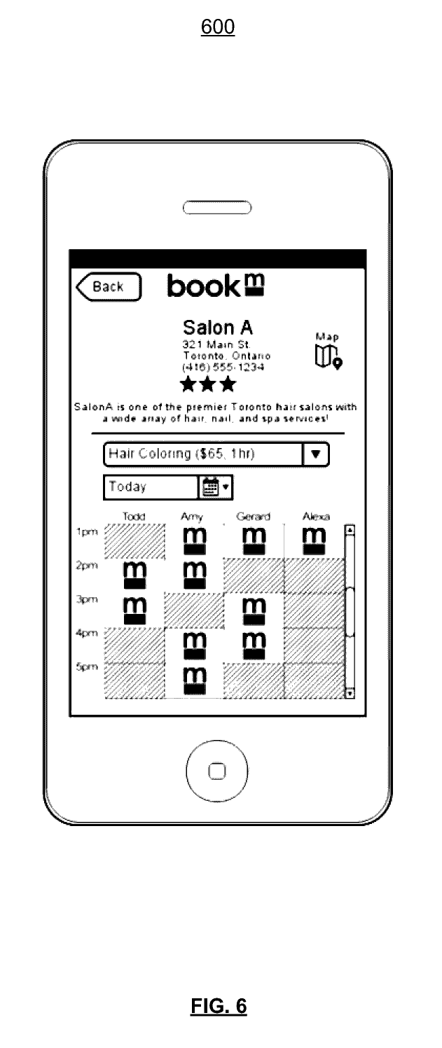

Referring to FIG. 6, there is shown a GUI 600 on a service-consumer device. The GUI 600 allows a service consumer to see the details of available appointments at a particular service-provider organization. For example, the service consumer may select “Salon A” from the list provided on GUI 400, and may then be shown the GUI 600, which displays a calendar view of available appointments at Salon A, and further information about Salon A such as contact information, a description, and a rating score (e.g. three out of five stars).

According to some embodiments, the GUI 600 allows the service consumer to select further details about the appointment that the service consumer wishes to book. For example, as shown in the example of FIG. 6, available appointments are shown in time slots on the calendar for “today”, and for appointments for “hair coloring” that are 1-hour in duration (and with a cost of $65). According to some embodiments, the service consumer may alter these selections, such as by choosing a date other than “today”, or by selecting s different type of service, etc.

According to some embodiments, the GUI 600 may also include a “map” button or link.

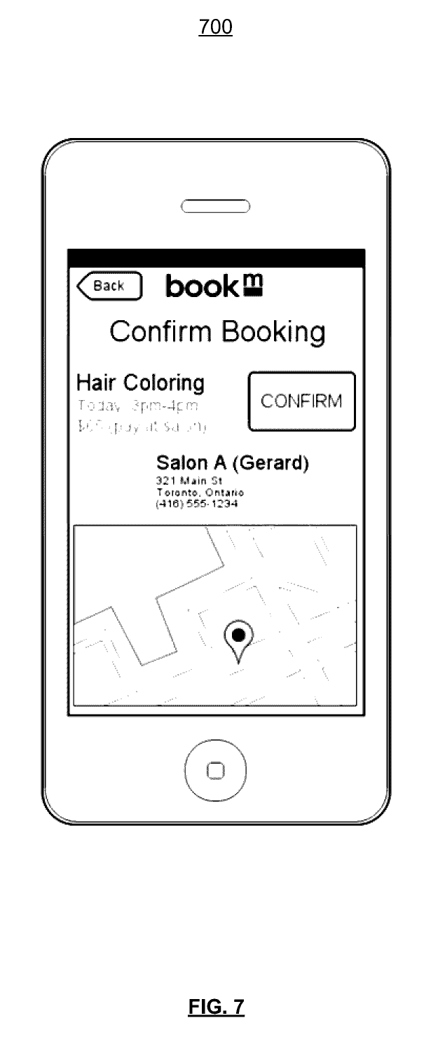

Referring to FIG. 7, there is shown a GUI 700 on a service-consumer device. The GUI 700 allows the service consumer to confirm the booking of the appointment that he or she would like to book. According to some embodiments, the service consumer may be presented with the GUI 700 after selecting a particular available appointment (e.g. by time slot) from the calendar view of the GUI 600.

For example, if the service consumer chooses the available appointment with Gerard in the time slot from 3 pm to 4 pm today, for a hair coloring ($65, 1 hour), then the service consumer will be presented with the GUI 700 as provided in the example of FIG. 7.

When the service consumer selects the “confirm” button, the service-consumer device provides the selected appointment details to the service-appointment server. According to some embodiments, the service-appointment server may automatically update the service-appointment database to indicate that the selected appointment is no longer available for future bookings. According to other embodiments, the service-provider organization (using the service-provider-organization device) or the service-provider individual (using the service-provider-individual device) provides an instruction to the service-appointment server to update the service-appointment database to indicate that the selected appointment is no longer available.

According to some embodiments, when the service-appointment server receives the selected appointment details when the booking is being confirmed, the service-appointment server can send a confirmation message to the service-provider organization via the service-provider-organization device, and/or to the service-provider individual via the service-provider-individual device. In the example of FIG. 7, the service-provider organization Salon A, and the service-provider individual is Gerard.

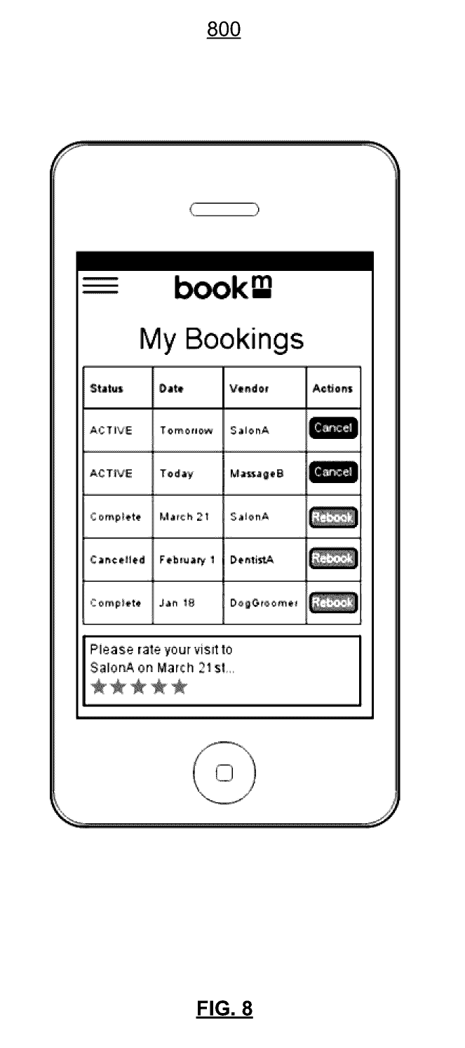

Referring to FIG. 8, there is shown a GUI 800 on a service-consumer device. The GUI 800 displays a list of upcoming and recent appointment bookings pertaining to the service consumer. According to some embodiments, the service consumer may be presented with the GUI 800 after clicking the “My Bookings” button such as on the GUI 300.

The GUI 800 displays a list of upcoming and recent appointment bookings pertaining to the service consumer. According to some embodiments, the GUI 800 also includes a “cancel” button that allows the service consumer to cancel upcoming appointments, as well as a “rebook” button that allows the service consumer to book a future appointment based on a previous appointment.

According to some embodiments, clicking the “rebook” button sends search criteria from the service-consumer device to the service-appointment server, in order to initiate a search. In such a case, the search criteria may automatically include the same service-provider organization and service-provider individual, as well as the same type or category of service as the previous appointment.

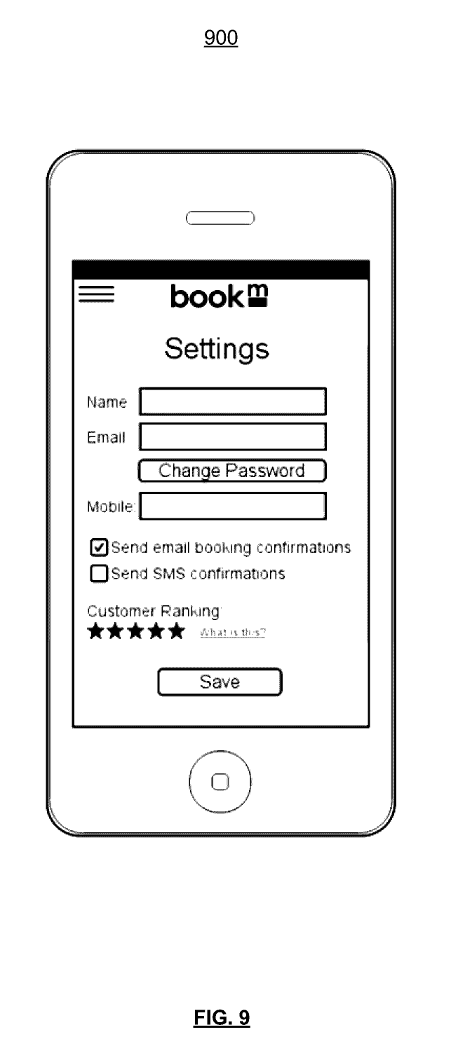

Referring to FIG. 9, there is shown a GUI 900 on a service-consumer device. The GUI 900 allows the service consumer to further specify settings associated with the service consumer's user account. For example, a service consumer may select to have booking confirmations sent from the service-appointment server to his or her service-consumer device via email and/or SMS messaging (which might be dependent on the particular service-consumer device's capabilities).

According to some embodiments, the GUI 900 may further include a rating indicator (e.g. “Customer Ranking”) pertaining to the service consumer. This rating indicator may indicate the reliability of the service consumer, or other experiences of the service-provider organization or service-provider individual with respect to the service consumer. For example, the rating indicator may be based on the service consumer's failure to attend one or more previously-scheduled appointments.

According to some embodiments, when a service consumer has booked an appointment and then fails to attend the appointment (i.e. is a “no show”), the service-provider organization can use the service-provider-organization device to provide instructions to the service-appointment server to update the rating indicator associated with the service consumer to reflect the fact that the service consumer failed to attend the booked appointment.

According to some embodiments, when a service consumer attempts to confirm an appointment booking, the rating indicator associated with the service consumer can be provided to the service-provider organization. Based on the rating indicator, the service-provider organization may refuse the appointment booking, or put conditions on the appointment.

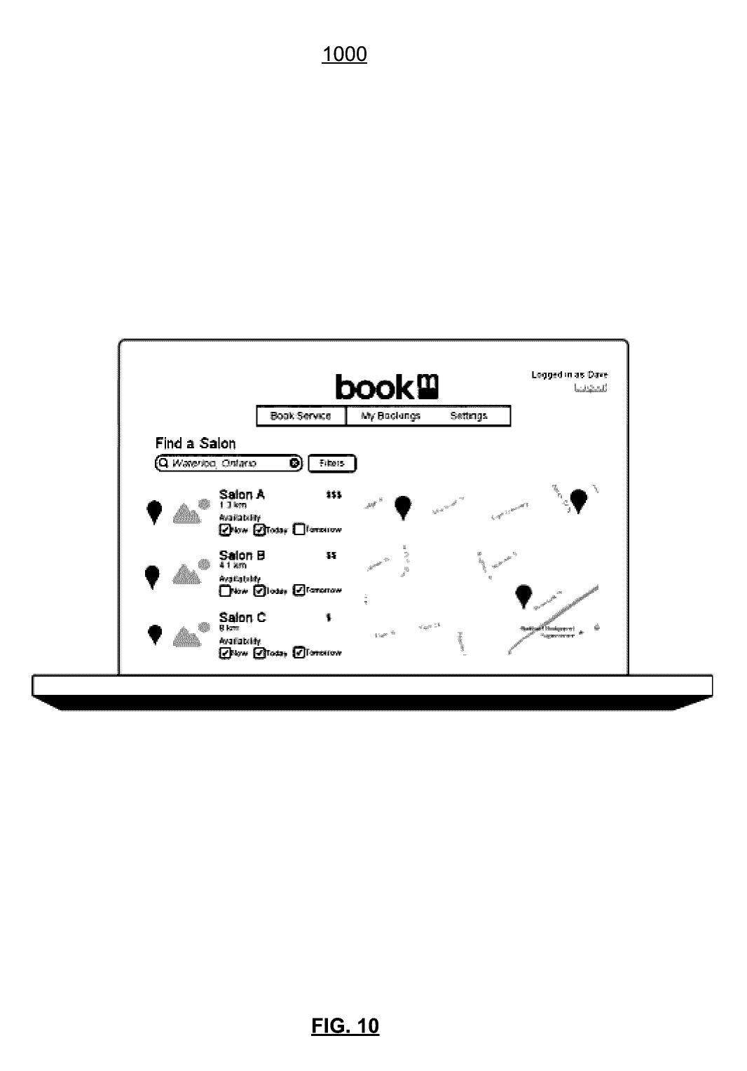

Referring to FIG. 10, there is shown an example of a service-consumer device 1000 using a laptop computer. In the particular example shown, a GUI displays example location-based search results as were described in FIG. 4. Since the example service-consumer device 1000 includes a larger screen size than the example shown in FIG. 4, the GUI displays a map that provides a visual indication of the location of the service providers listed in the location-based search results.

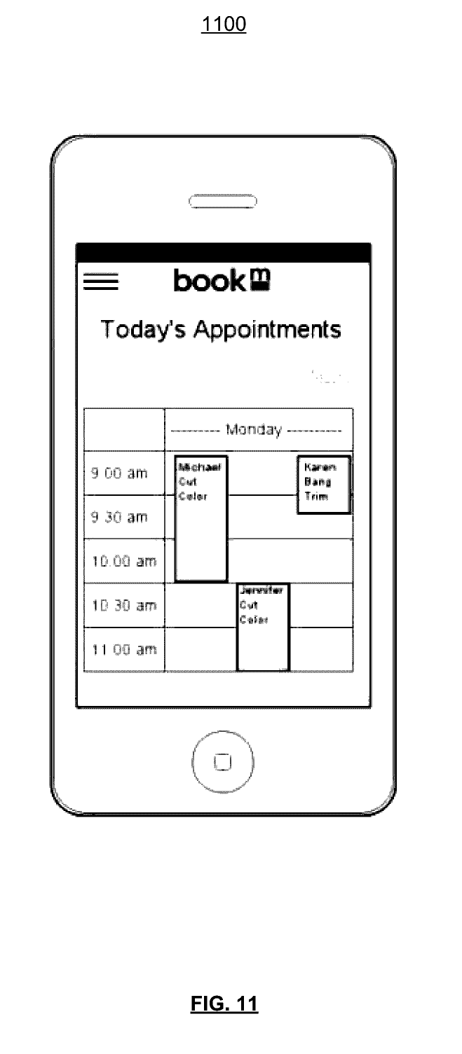

Referring to FIG. 11, there is shown a GUI 1100 on a service-provider-organization device that is displayed when a manager of a service-provider organization selects a calendar view of the appointments currently scheduled for the service-provider organization. In the example provided, booked appointments are displayed for “today” (Monday).

In the example provided by FIG. 11, the service-provider organization (e.g. “Salon A”) has at least three service-provider individuals working for it: Michael, Karen, and Jennifer. According to today's appointments schedule, Michael is scheduled to provide the services of cut and color from 9:00 am to 10:30 am; Karen is scheduled to provide the service of a bang trim from 9:00 am to 9:45 am; and Jennifer is scheduled to provide the services of a cut and color from 10:30 am until sometime after 11:30 am.

According to some embodiments, a menu button is provided in the top left corner of the GUI 1100, which allow the manager (or other employee) of the service-provider organization to navigate to GUIs that provide “Today's Appointments” (e.g. the GUI 1100), “Book an Appointment”, “Staff Schedule”, and “Vendor Setup”.

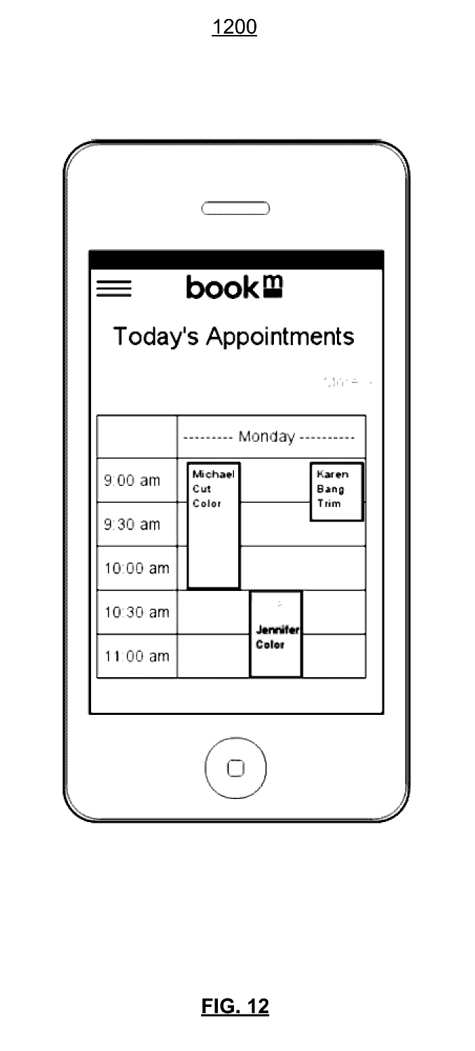

Referring to FIG. 12, there is shown a GUI 1200 on a service-provider-organization device that is displayed when a manager of a service-provider organization selects a calendar view of the appointments currently scheduled for the service-provider organization. The GUI 1200 is essential the same as the GUI 1100, except that it indicates there is a new booking for Jennifer to provide the service of “color” from 10:30 am to 11:30 am.

When a service consumer confirms the booking of an appointment, for example, using the GUI 700 as previously described in reference to FIG. 7, the selected appointment details are provided to the service-appointment server. According to some embodiments, the service-appointment server may subsequently send a message to update the service-provider-organization device that a new appointment has been booked.

According to some embodiments, when the service-provider-organization device receives a message from the service-appointment server regarding a new booking, the service-provider-organization device may automatically display the new booking on the GUI 1200. According to some embodiments, the new booking may be indicated by any type of visual indicia, such as a symbols, text, color, etc.

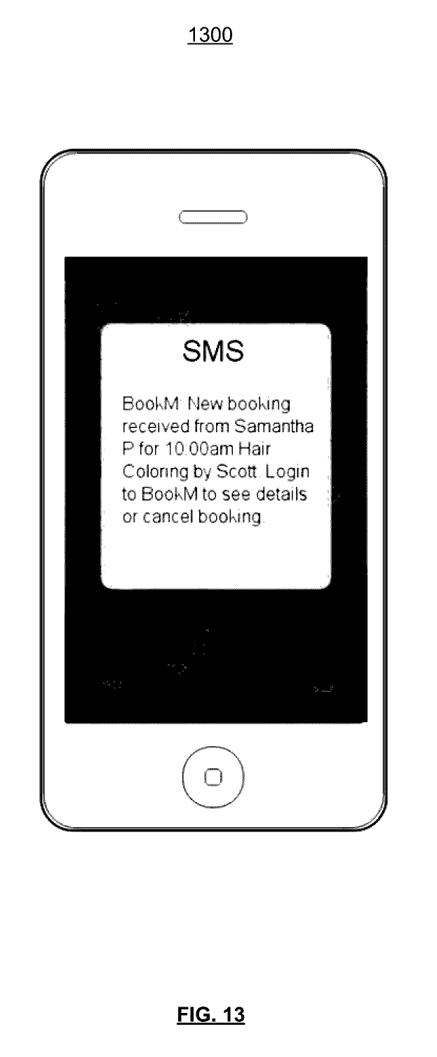

Referring to FIG. 13, there is shown a GUI 1300 on a service-provider-organization device (or a service-provider-individual device) that is displayed when the device receives a message regarding a new booking from the service-appointment server, according to some embodiments. According to the embodiment depicted in FIG. 13, the service-appointment server sends an SMS message (text message) to the service-provider-organization device and/or the service-provider-individual device in order to alert the service-provider organization and/or the service-provider individual that a new booking has been made. According to some embodiments, the use of a messaging service such as SMS, email, etc., which is independent of a GUI displaying an appointment schedule, allows for a service-provider organization or service-provider individual to receive an update message about a new appointment event when the appointment schedule (e.g. GUI 1200) is not currently being viewed.

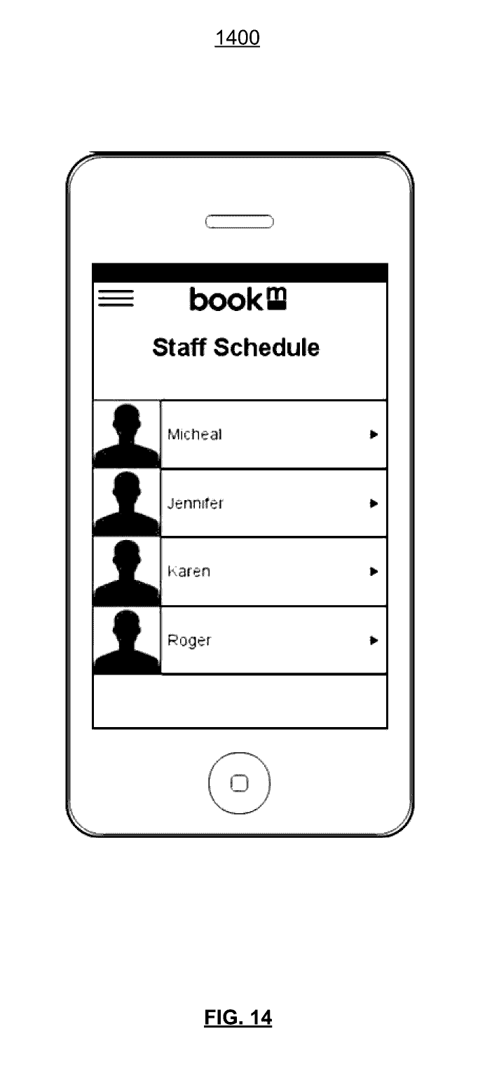

Referring to FIG. 14, there is shown a GUI 1400 on a service-provider-organization device that is displayed, for example, when a user selects “Staff Schedule” from the menu (e.g. as located in the top left corner of GUI 1400). The GUI 1400 lists the service-provider individuals (e.g. employees) of the service-provider organization, which, in the example provided, are Michael, Jennifer, Karen, and Roger. Using the GUI 1400, a user is able to select the particular service-provider individual's schedule that he or she wishes to view. According to some embodiments, when the user selects a particular service-provider individual, the user is shown a GUI that displays the weekly schedule of appointments for that particular service-provider individual.

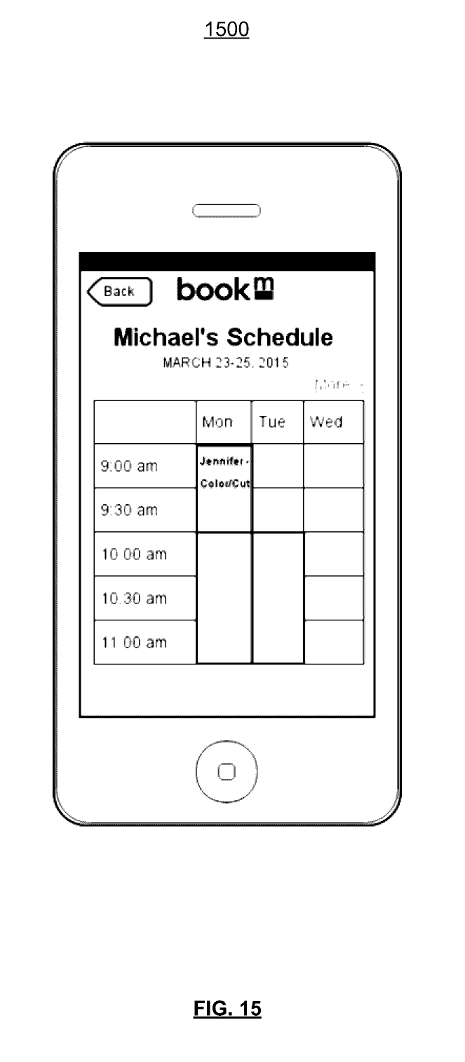

Referring to FIG. 15, there is shown a GUI 1500 that is displayed when a user selects “Michael” on the GUI 1400. The GUI 1500 displays the schedule of appointments for Michael during Mar. 23-25, 2015. As shown, Michael is scheduled to provide the services of color/cut for Jennifer (the service consumer) on Monday from 9:00 am to 10:00 am. According to some embodiments, a user is able to select an appointment displayed on the GUI 1400 in order to view appointment details pertaining to that appointment.

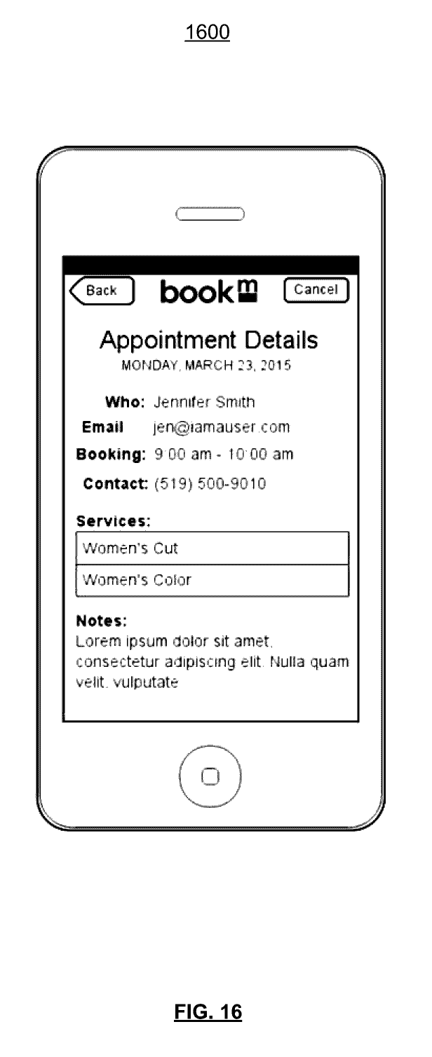

Referring to FIG. 16, there is shown a GUI 1600 that is displayed when a user selects the “Jennifer—cut/color” appointment on the GUI 1500. The GUI 1600 displays appointment details pertaining to the “Jennifer—cut/color” appointment, which include the name of the service consumer (“Jennifer Smith”), the contact details of the service consumer (email address, phone number), the time slot for the appointment (9:00 am-10:00 am), the services being provided (“Women's Cut” and “Women's Color”), as well as notes that can be associated with the appointment.

According to some embodiments, the GUI 1600 may include a “Cancel” button, which, in the embodiment shown in FIG. 16, is shown in the upper-right corner. When a user selects the “Cancel” button, the service-provider-organization device provides instructions to the service-appointment server to record the available-unavailable indicator associated with the appointment to indicate “available” in the service-appointment database.

According to some embodiments, when a user selects the “Cancel” button, the service-provider-organization device may provide instructions to the service-appointment server to send a message (e.g. via SMS and/or email) to the associated service consumer in order to notify the service consumer that the appointment was cancelled by the service-provider organization.

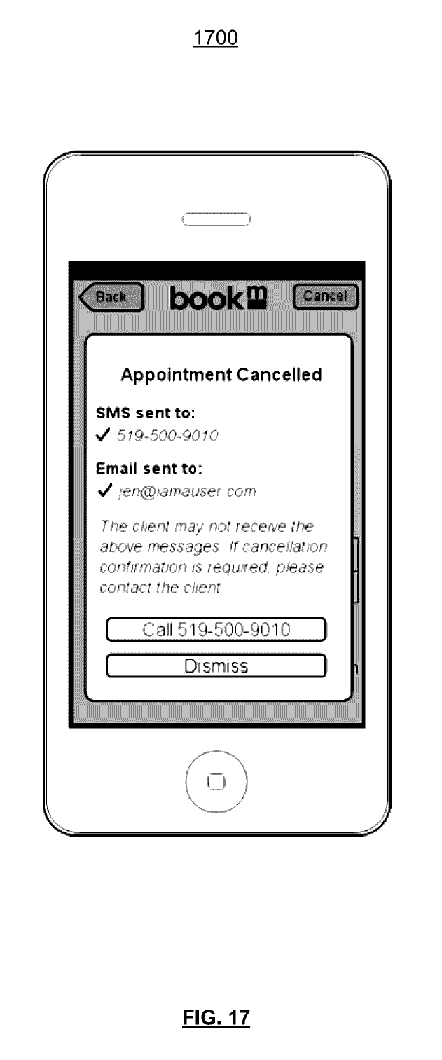

Referring to FIG. 17, there is shown a GUI 1700 on a service-provider-organization device. The GUI 1700 displays a confirmation of an appointment cancelation. According to some embodiments, the GUI 1700 may be displayed when the “Cancel” button is selected on the GUI 1600.

According to some embodiments, the GUI 1700 may include a link or button so that the service consumer whose appointment has been cancelled can be easily telephoned from the service-provider-organization device.

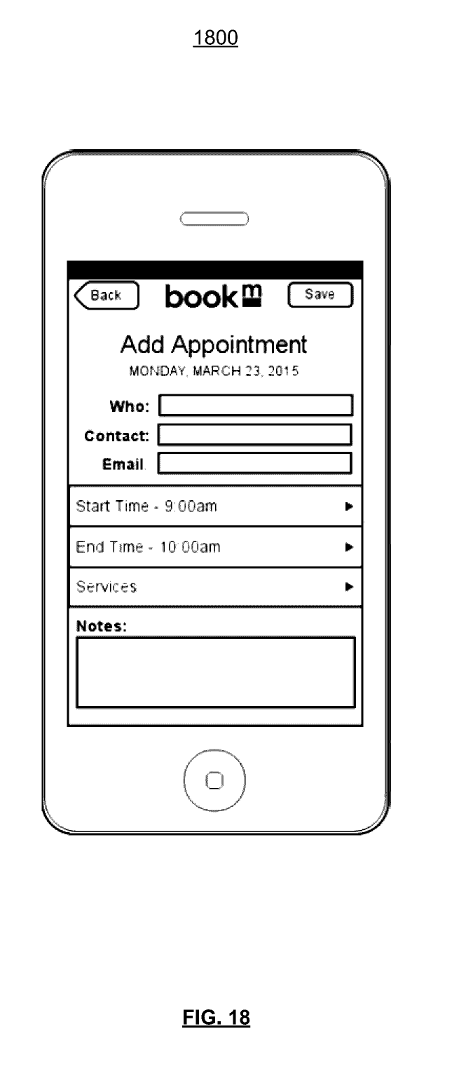

Referring to FIG. 18, there is shown a GUI 1800 on a service-provider-organization device or a service-provider-individual device. The GUI 1800 allows a manager of a service-provider organization using a service-provider-organization device or a service-provider individual using a service-provider-individual device to add an appointment. For example, an appointment may be added in this way, if a service consumer calls the service provider, or visits the service provider in person.

According to some embodiments, the GUI 1800 allows the user to input the name of the service consumer to whom the appointment pertains, contact information for the service consumer (e.g. telephone number, email address), the time slot associated with the appointment (e.g. as defined by a start time and an end time), the particular service being provided during the appointment (e.g. women's cut), and notes associated with the appointment booking.

The GUI 1800 includes a button (e.g. the “Save” button shown in the top right corner of GUI 1800). When a user clicks the “Save” button, the details associated with the appointment (e.g. service consumer details, time slot, service being provided, etc.) are sent from the service-provider-organization device (or service-provider-individual device, as the case may be) to the service-appointment server so that they can be recorded in the service-appointment database.

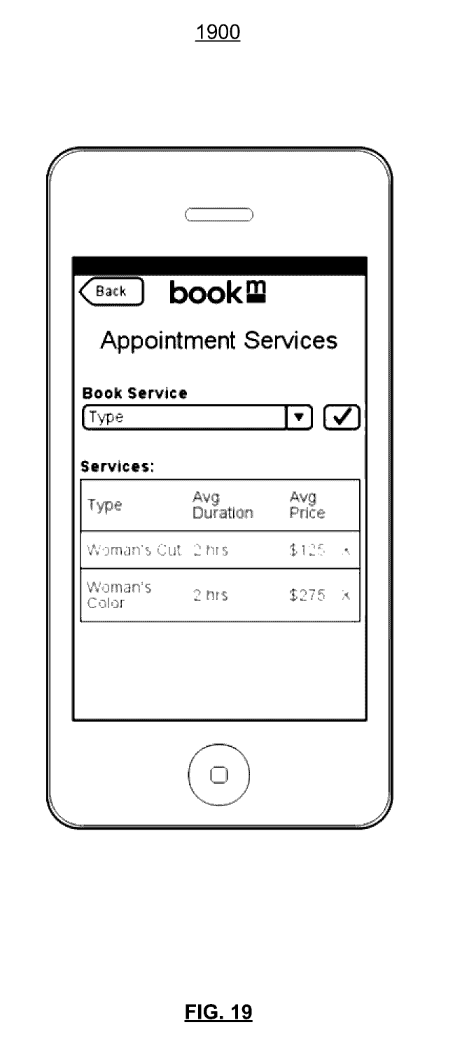

Referring to FIG. 19, there is shown a GUI 1900 on a service-provider-organization device or a service-provider-individual device. The GUI 1900 allows a manager of a service-provider organization using a service-provider-organization device or a service-provider individual using a service-provider-individual device to provide further details of the service that will be provided for an appointment that is being booked. The GUI 1900 may be displayed to a user when the user selects the “Services” button shown on the GUI 1800 of FIG. 18.

According to some embodiments, the GUI 1900 includes a drop-down list of available services that can be added to the appointment services, and a list showing the services that have already been selected for the appointment. A user can add services to the list using the drop-down list, or delete a service from the list using the GUI 1900.

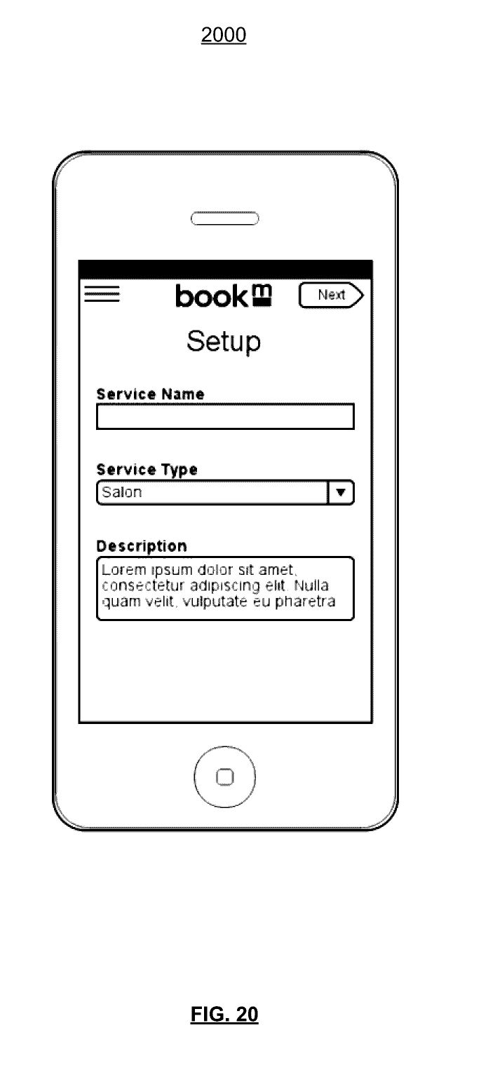

Referring to FIG. 20, there is shown a GUI 2000 on a service-provider-organization device. The GUI 2000 allows a manager of a service-provider organization to set or change details pertaining to the service-provider organization. According to some embodiments the name of the service-provider organization may be set or changed, as well as the service type (e.g. “Salon”). According to some embodiments, the service type may be used to associate the particular service-provider organization with a particular icon, such as on the GUI 2 and the GUI 3.

According to some embodiments, the GUI 2000 may include a “Next” button. When the “Next” button is selected, the service-provider-organization device may send the details pertaining to the service-provider organization to the service-appointment server, which will subsequently record the details in the service-appointment database. Furthermore, when the “Next” button is selected, a subsequent GUI may be presented so that the user can provide additional details pertaining to the service-provider organization.

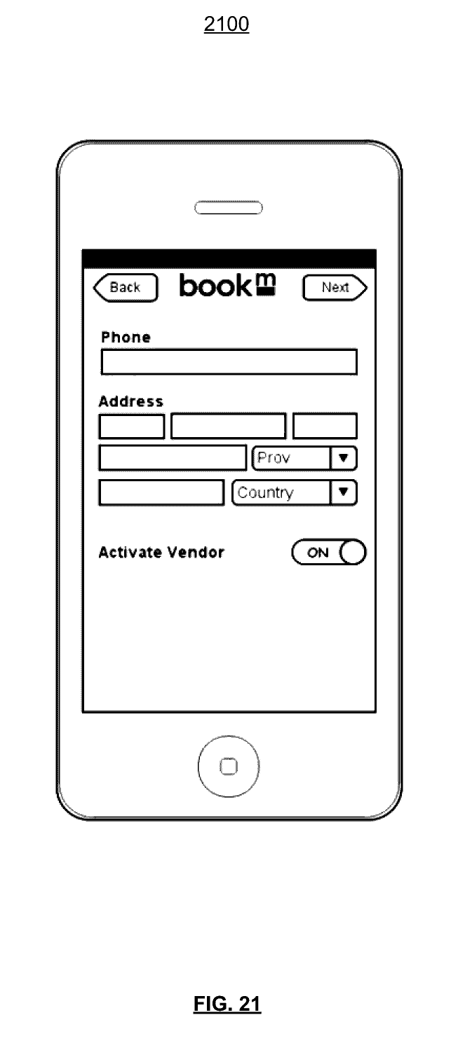

Referring to FIG. 21, there is shown a GUI 2100 on a service-provider-organization device. The GUI 2100 allows a user to set or change a phone number, mailing address, and other contact details pertaining to the service-vendor organization.

According to some embodiments, the GUI 2100 may include an “Activate Vendor” switch. When the “Activate Vendor” switch is activated (e.g. switched to “on”), the service-provider-organization device instructs the service-appointment server to record in the service-appointment database that the particular service-provider organization is generally available for use and display within search results in response to a search by a service consumer. In other words, if the “Activate Vendor” switch is deactivated, information pertaining to the service-provider organization will not be visible to a service consumer.

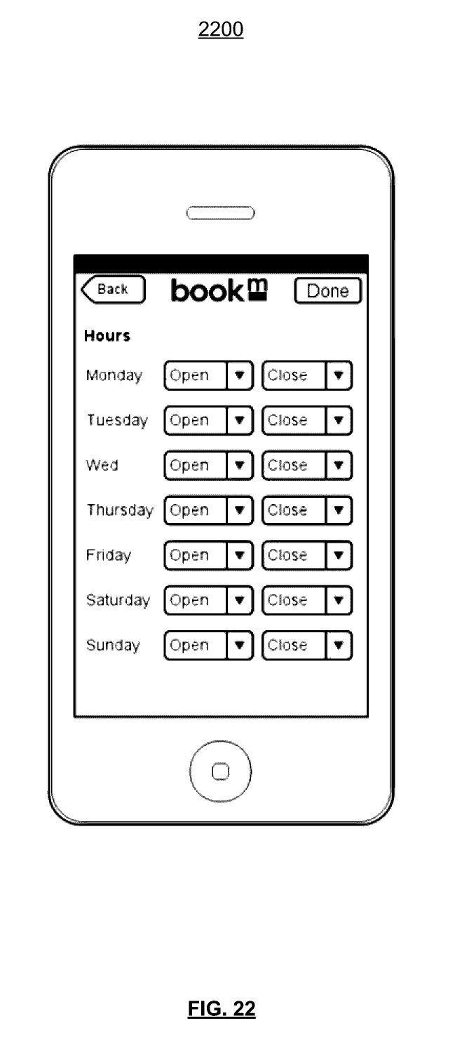

Referring to FIG. 22, there is shown a GUI 2200 that may be displayed by a service-provider-organization device according to some embodiments. The GUI 2200 allows a user to set the hours of operation pertaining to the service-provider organization. When the user clicks the “Done” button, the service-provider-organization device sends an instruction to the service-appointment server so that an active-inactive indicator associated with the time slots corresponding to the operating hours can be set to indicate “active” in the service-appointment database.

According to some embodiments, the active-inactive indicator in the service-appointment database is defined in the database at the service-provider-organization level. That is to say, the active-inactive indicator indicates when the entire organization (e.g. company, store, clinic, salon, etc.) is open for business. According to some embodiments, this is distinct from the available-unavailable indicator which is defined in the database at the service-provider-individual level. That is to say, the available-unavailable indicator indicates when a particular service-provider individual within the service-provider organization is available for an appointment.

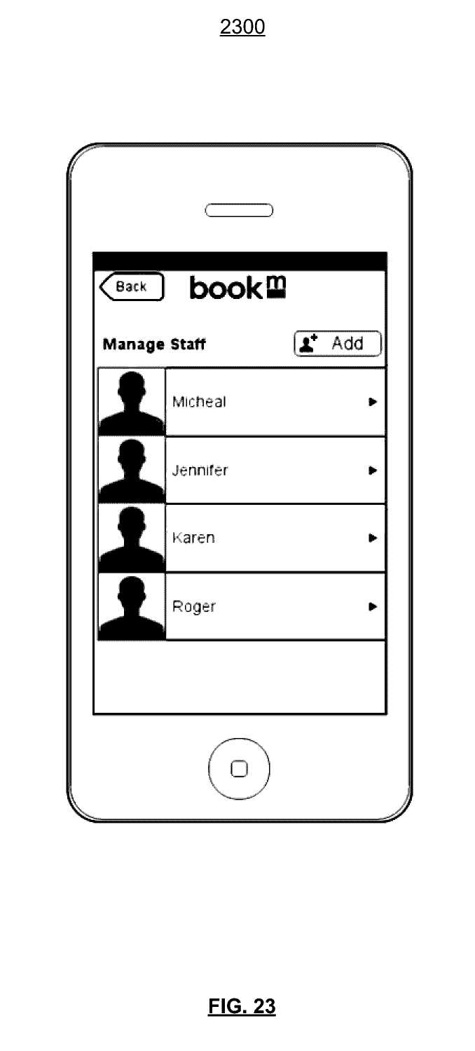

Referring to FIG. 23, there is shown a GUI 2300 that may be displayed by a service-provider-organization device according to some embodiments. The GUI 2300 allows a manager of the service-provider organization to add or manage staff members (i.e. service-provider individuals). The GUI 2300 lists the current service-provider individuals within the service-provider organization, and also includes an “Add” button for adding new service-provider individuals. When a member of the list or the “Add” button is selected by a user, the user is presented with a subsequent GUI that allows for details pertaining to the service-provider individual to be added or changed.

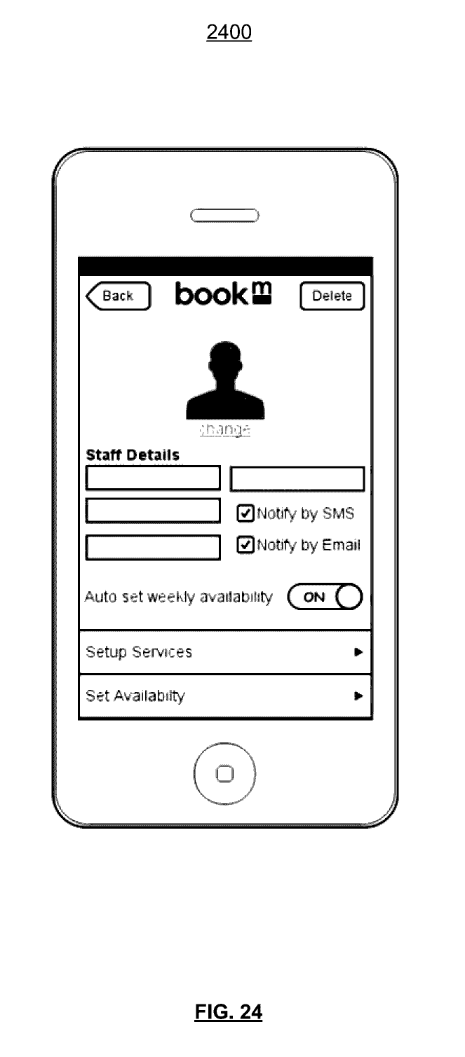

Referring to FIG. 24, there is shown a GUI 2400 that may be displayed by a service-provider-organization device according to some embodiments. The GUI 24 may be displayed, for example, when a member of the list or the “Add” button on the GUI 2300 is selected.

The GUI 2400 allows a user to provide details pertaining to a service-provider individual. For example, the details may include the name and contact information pertaining to the service-provider individual. According to some embodiments, the GUI 2400 may also include details such as whether the service-provider individual will be contacted by SMS or Email (e.g. when new appointments are booked), and whether the service-provider individual will be have his or her weekly availability automatically set. The GUI 2400 may also include buttons or links to additional GUIs so that the services associated with the service-provider individual can be set or changed, as well as the availability associated with the service-provider individual.

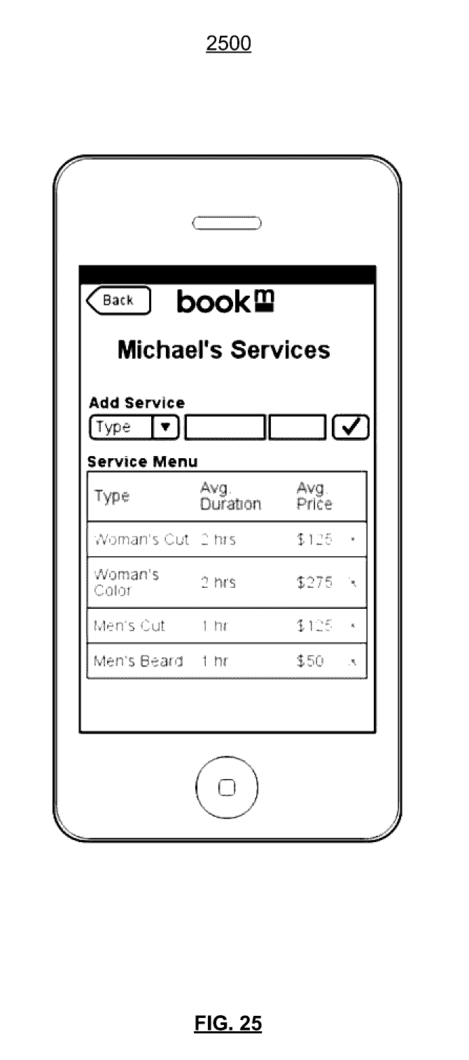

Referring to FIG. 25, there is shown a GUI 2500 that may be displayed by a service-provider-organization device according to some embodiments. The GUI 25 may be displayed, for example, when a button or link to set up or change a service-provider individual's associated services on the GUI 2400 is selected. In the example shown in FIG. 25, the GUI 2500 is displayed to the user when the service-provider individual “Michael” is selected on the GUI 2300, and then “Setup Services” is selected on the GUI 2400.

The GUI 2500 includes a drop-down list of services that can be associated with the service-provider individual, as well as an associated duration and price for the service. The GUI 2500 also includes a list of the services that are currently associated with the service-provider individual. Services can be added to the list or deleted from the list.

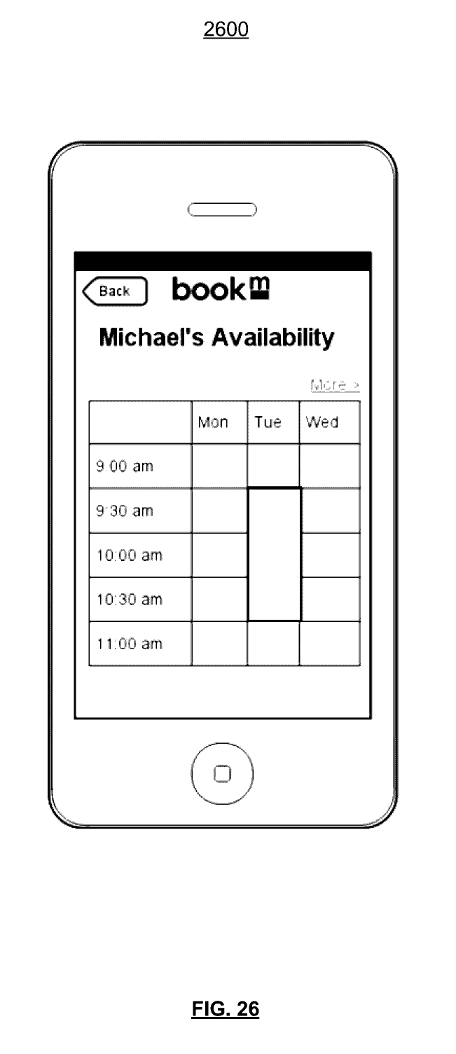

Referring to FIG. 26, there is shown a GUI 2600 that may be displayed by a service-provider-organization device or a service-provider-individual device according to some embodiments. The GUI 2600 may be displayed, for example, when a button or link to set a service-provider individual's availability on the GUI 2400 is selected. In the example shown in FIG. 26, the GUI 2600 is displayed to the user when the service-provider individual “Michael” is selected on the GUI 2300, and then “Set Availability” is selected on the GUI 2400.

The GUI 2600 provides a calendar view of the service-provider individual's schedule of availability. A user can select a time slot, and then subsequently specify the details of the time slot using a different GUI.

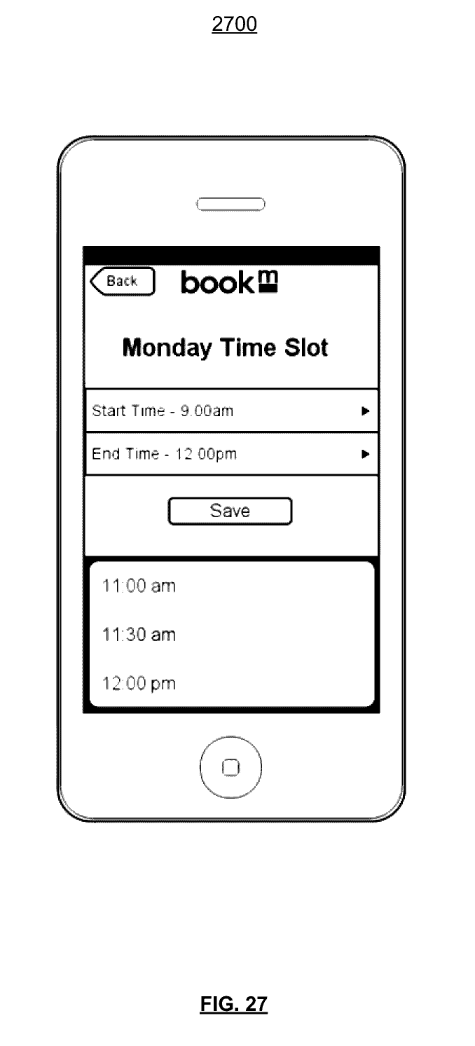

Referring to FIG. 27, there is shown a GUI 2700 that may be displayed by a service-provider-organization device or a service-provider-individual device according to some embodiments. The GUI 2700 may be displayed, for example, when a time slot on the GUI 2600 is selected. Using the GUI 2700, the start time and the end time of the time slot for which the service-provider individual is available. Multiple time slots may be set as available during any particular day, for example, to allow for breaks, lunch, etc.

The GUI 2700 includes a “Save” button. When a user selects the “Save” button, the service-provider-organization device (or the service-provider-individual device, as the case may be) sends information pertaining to the time slot to the service-appointment server, which subsequently sets the available-unavailable indicator corresponding to the time slot in the service-appointment database.

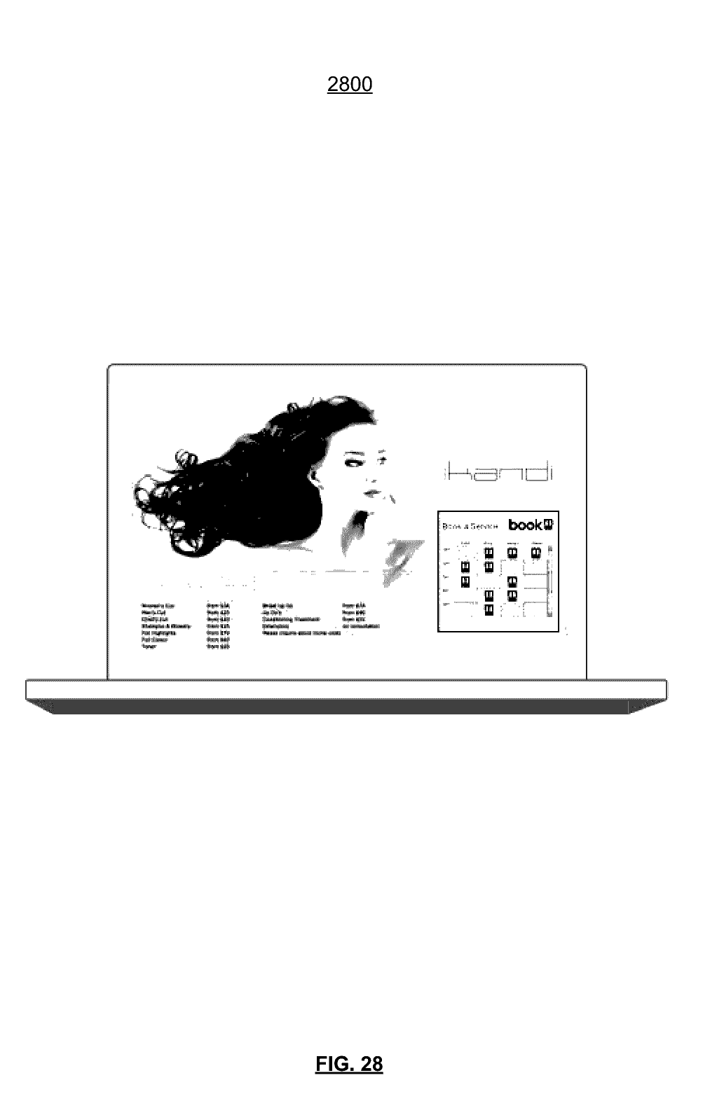

Referring to FIG. 28, there is shown a service-provider-organization's website 2800. The website 2800 includes a plugin GUI 2802, which allows for the service-provider organization to display the service-provider-organization's appointment schedule from a service-appointment database on the website 2800.

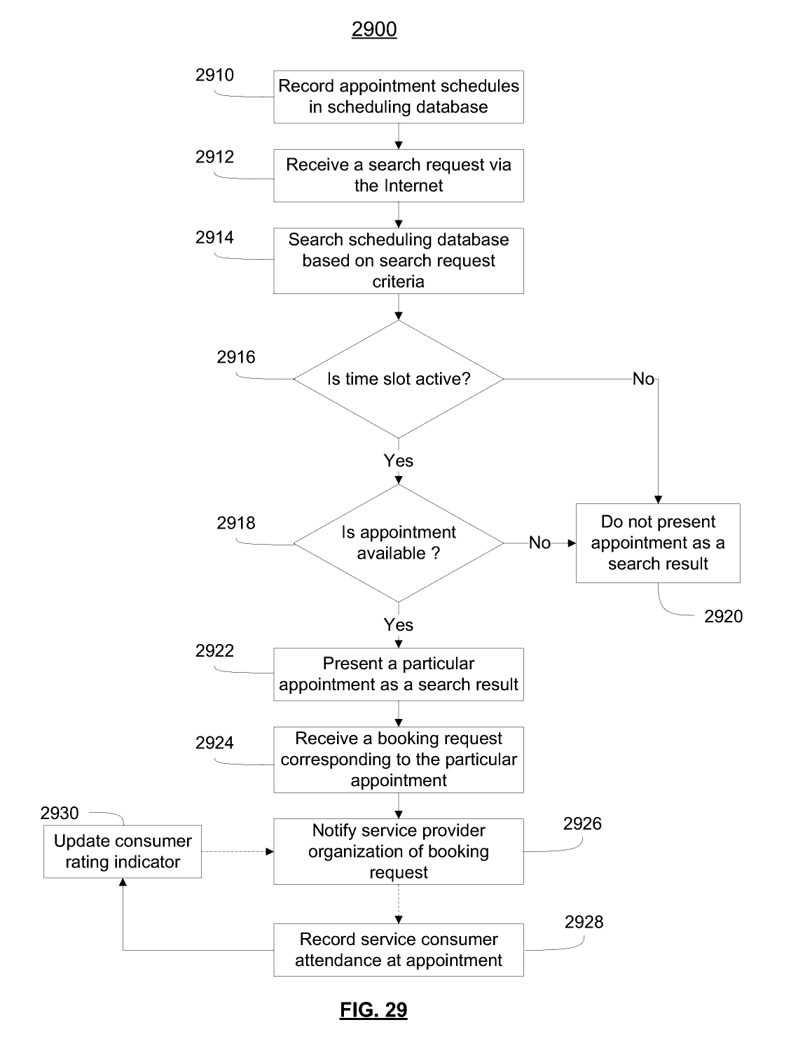

Referring to FIG. 29, there is shown a method 2900 for booking an appointment within a scheduling database connected to the Internet.

The method begins at step 2910, at which appointment schedules are recorded in a scheduling database. Each appointment schedule is associated with a particular service-provider organization, and each appointment schedule comprises one or more appointments. Each appointment is associated with a time slot, and an available/unavailable indicator. The available/unavailable indicator is used to record or determine whether the associated appointment is available for future booking, or if the appointment has already been booked. According to some embodiments, a particular appointment can be associated with a particular service-appointment individual (e.g. with a particular stylist at a salon).

At step 2912, a search request is received from a service-consumer device via the Internet. According to some embodiments, a search request can include criteria such as type of service-provider organization, appointment time(s), types of services provided, product brands provided by the service provider, name of service-provider organization and/or individual, consumer ratings, previous bookings by the service consumer, etc. According to some embodiments, the location may be automatically provided, such as with a GPS receiver. According to some embodiments, the desired appointment time(s) may be automatically provided based on service-consumer calendar data stored on the service-consumer device.

At step 2914, the scheduling database is searched based on the search request criteria, and a search result is determined. The search result is associated with a particular appointment.

At step 2916, the method determines whether the active/inactive indicator associated with the particular appointment indicates that the associated time slot is “active” or “inactive”. According to some embodiments, the active/inactive indicator may be set by the service-provider organization, and may pertain to multiple time slots, in order to indicate when the service-provider organization is open for business. If the indicator indicates “inactive”, then the method proceeds to step 2920, and the search result is not presented to the service-consumer device.

If, at step 2916, the method determines that the particular appointment is associated with an active time slot, then the method proceeds to step 2918.

At step 2918, the method determines whether the available/unavailable indicator associated with the particular appointment indicates “available” or “unavailable”. If the indicator indicates “unavailable” (meaning that the particular appointment has already been booked; e.g. someone else has an appointment with the associated service-provider individual during the associated time slot), then the method proceeds to step 2920, and the search result is not presented to the service-consumer device.

The available/unavailable indicator differs from the active/inactive indicator. According to some embodiments, the active/inactive indicator may be set at the service-provider organization level, such as to indicate business hours, whereas the available/unavailable indicator may be set at the service-provider individual level, in order to indicate that an appointment corresponding to a particular time slot is available for booking. According to some embodiments, a service-provider individual device may be used to manage availability/unavailability separately from the active/inactive indicator managed on a service-provider organization device.

If, at step 2918, the method determines that the particular appointment is “available”, then the method proceeds to step 2922.

At step 2922, the search result comprising the particular appointment is presented to the service-consumer device. If the service consumer using the service-consumer device decides to book the appointment associated with the search result, then the method proceeds to step 2924.

At step 2924, a booking request corresponding to the particular appointment from the service-consumer device is received from the service-consumer device.

At step 2926, the service-provider organization device (and, according to some embodiments, the service-provider individual device) is notified of the booking request. According to some embodiments, at step 2926, the available/unavailable indicator associated with the appointment is set to “unavailable.”

At some time after the appointment is booked with the service-provider organization, the time of the appointment occurs. (This is indicated by the stippled line between steps 2926 and 2928). The service consumer may or may not show up at the booked appointment.

According to some embodiments, at step 2928, the attendance of the service consumer (or lack of attendance) can be recorded using a service-provider organization device or a service-provider individual device. If this is done, then the method proceeds to step 2930.

According to some embodiments, at step 2930, the attendance (or lack thereof) of the service consumer at the booked appointment can be used to generate or update a service-consumer rating indicator. For example, if the service consumer does not attend the booked appointment, then the service consumer's rating indicator may be updated to reflect a reduced or negative score.

According to some embodiments, the rating indicator may be included in the notification of a booking request that is sent to a service provider at some future occurrence of step 2926. (The future occurrence is indicated by the stippled line, to distinguish from a continuous loop). For example, at step 2926, a service provider may be notified of the rating indicator associated with the service consumer making the booking request. If the service provider is not satisfied with the rating indicator, the service provider may take further actions, such as refusing the booking, or requesting pre-payment, etc.

While the above description provides examples of one or more apparatus, methods, or systems, it will be appreciated that other apparatus, methods, or systems may be within the scope of the claims as interpreted by one of skill in the art.

1. A method for booking an appointment within a scheduling database connected to an Internet, comprising:
recording on at least one non-transitory computer-readable medium a plurality of appointment schedules in the scheduling database, the recording comprising:
associating each appointment schedule with a service-provider organization and a plurality of appointments,
associating each appointment with a service-provider individual within the service-provider organization, a time slot, and an associated available-unavailable indicator;
receiving a service-provider search request from a service consumer via the Internet;
presenting a search result to the service consumer based on the search request, the search result corresponding to a particular appointment;
receiving a booking request from the service consumer corresponding to the particular appointment; and
notifying the service provider organization of the booking request.

2. The method of claim 1, wherein the step of recording a plurality of appointment schedules further comprises associating each appointment schedule with a plurality of active-inactive time periods and associating each active-inactive time period with an active-inactive indicator; and
if the active-inactive indicator indicates inactive, and the active-inactive time period corresponds to the time slot of the particular appointment, then the step of presenting the search result further comprises not presenting the search result.

3. The method of claim 1, wherein the search request comprises a location and a maximum distance, and wherein the search results are derived from a location- based search for service-providers located within a proximity of the location defined by the maximum distance.

4. The method of claim 3 wherein the location is automatically determined by a global-positioning system receiver associated with the service consumer.

5. The method of claim 1, further comprising recording on the at least one non-transitory computer-readable medium a rating indicator pertaining to the service consumer, based on a failure by the service consumer to attend a previously-scheduled appointment.

6. The method of claim 1, further comprising recording on the at least one non-transitory computer-readable medium a feature listing indicator in association the service-provider organization; and
wherein the step of presenting the search result further comprises presenting the search result in an order relative to a second search result that is based on the feature listing indicator.

7. A system for booking appointments for a multitude of service consumers on an Internet and managing the appointments by a multitude of service-provider organizations and service-provider individuals via the Internet, the system comprising:
a service-appointment server having a service-appointment processor;
at least one non-transitory computer-readable medium storing a service-appointment database, the database storing an appointment schedule associated with a service-provider organization, the appointment schedule comprising an appointment associated with a service-provider individual within the service-provider organization and an available-unavailable indicator, the service-appointment database being in communication with the service-appointment server;
a service-consumer device having a service-consumer processor, the service-consumer device being in communication with the service-appointment server via the Internet;
a service-provider-organization device having a service-provider-organization processor, the service-provider-organization device being in communication with the service-appointment server via the Internet; and
a service-provider-individual device having a service-provider-individual processor device in communication with the service-appointment server via the Internet;
the service-consumer processor configured to:
provide a service-provider search request to the service-appointment server;
receive a service-provider search result from the service-appointment server; and
provide a selected appointment from the service-provider search results to the service-appointment server;
the service-appointment processor configured to:
receive the service-provider search request from the service-consumer device;
provide the service-provider search results based on the database and the service-provider search request;
receive the selected appointment from the service-consumer device;
provide a service-provider-organization booking message to the service-provider-organization device pertaining to the selected appointment; and
provide a service-provider-individual booking message to the service-provider-individual device pertaining to the selected appointment;
the service-provider-organization processor configured to:
provide the database with the appointment schedule; and
receive the service-provider-organization booking message from the service-appointment server;
the service-provider-individual processor configured to:
update the available-unavailable indicator pertaining to the appointment; and
receive the service-provider-individual booking message from the service-appointment server.

8. The system of claim 7, wherein the appointment schedule is associated with a plurality of active-inactive time periods;
the service-provider-organization processor is further configured to update an active-inactive indicator associated with each of the active-inactive time periods; and
the service-appointment processor is further configured to provide the service-provider search results if and only if the active-inactive indicator associated with the active-inactive time period corresponding to the selected appointment indicates active.

9. The system of claim 7, wherein the service-consumer device further comprises a global-positioning-system receiver;
the service-provider search request comprises a location automatically determined by the global-positioning-system receiver and a maximum distance; and
the service-provider search results are derived from a location-based search for service-providers located within a proximity of the location defined by the maximum distance.

10. The system of claim 7, wherein the service-appointment processor is further configured to determine a service-consumer rating indicator pertaining to a service consumer based on a failure by the service consumer to attend a previously-scheduled appointment; and
wherein at least one of the service-provider-organization booking message and the service-provider individual booking message comprise the service-consumer rating indicator.

11. The method of claim 7, wherein the service-provider-organization processor is further configured to provide a feature listing indicator in association with a service-provider organization; and
the service-appointment processor is further configured to provide the search result in an order relative to a second search result that is based on the feature listing indicator.
